(19) United States
(12) Patent Application Publication
(10) Pub. No.: US 2006/0097235 A1
(43) Pub. Date: May 11, 2006

(54) Output adapter for power hand tool and lift jack using the same

(75) Inventor: Chien-Chun Wu, Taichung County (TW)

Correspondence Address: BACON & THOMAS, PLLC, 625 SLATERS LANE, FOURTH FLOOR, ALEXANDRIA, VA, 22314, US

(73) Assignee: MOBILETRON ELECTRONICS CO., LTD., TAICHUNG HSIEN (TW)

(21) Appl. No.: 11/016,825

(22) Filed: Dec. 21, 2004

(30) Foreign Application Priority Data
Nov. 9, 2004 (TW) 93134178

(51) Int. Cl. B66F 3/00

(52) U.S. Cl. 254/126

(57) ABSTRACT

An output adapter for connecting between an output connector of a power hand tool and a rotary input connector of an apparatus for working. The output adapter includes an adapter body and a tubular handle. The adapter body has a first connector connectable to the output connector of the power hand tool, a second connector connectable to the rotary input connector of the apparatus, and a shank connected between the first connector and the second connector. The tubular handle is rotatably sleeved onto the shank of the adaptor body for holding by a user operating a power hand tool to drive a working apparatus through the output adapter.

### BACKGROUND OF THE INVENTION

1. Field of the Invention

The present invention relates generally to a power hand tool and more specifically, to an output adapter for a power hand tool, which allows the user to drive a lift jack with the power hand tool. The present invention also relates a lift jack driven by a power hand tool using the output adapter.

2. Description of the Related Art

Regular power hand tools, subject to the type of bit connected to the power output end, include power screwdriver, power drill, power wrench, and etc. These power hand tools have limitation for application. For example, most people carry a power wrench in their car for use to fasten/unfasten the bolts of the wheels when necessary. A power wrench for this purpose has a rectangular output connector for receiving a socket. A socket for use with a power wrench has a rectangular coupling hole at one end for receiving the rectangular output connector of a power wrench, and a hexagonal coupling hole at the other end for receiving a bolt or nut. Therefore, a power wrench can be used with a socket to turn a bolt or nut. However, a power wrench of this design cannot be used for other purpose.

### SUMMARY OF THE INVENTION

The present invention has been accomplished under the circumstances in view. It is the primary objective of the present invention to provide an output adapter for a power hand tool, which broadens the application of a power hand tool.

It is another objective of the present invention to provide a power hand tool and lift jack assembly, which enables the lift jack to be driven by a power hand tool.

To achieve these objectives of the present invention, the output adapter for connecting between an output connector of a power hand tool and a rotary input connector of an apparatus for working comprises an adapter body and a tubular handle. The adapter body comprises a first connector connectable to the output connector of the power hand tool, a second connector connectable to the rotary input connector of the apparatus, and a shank connected between the first connector and the second connector. The tubular handle is rotatably sleeved onto the shank of the adaptor body for holding by a user operating a power hand tool to drive a working apparatus through the output adapter.

In a preferred embodiment, the power hand tool is a power wrench and the working apparatus is a lift jack.

### BRIEF DESCRIPTION OF THE DRAWINGS

FIG. 1 is an exploded view of an output adapter for a power hand tool according to a first preferred embodiment of the present invention.

FIG. 2 is a top plain view of the output adapter for a power hand tool according to the first preferred embodiment of the present invention.

FIG. 3 is a sectional view of the output adapter for a power hand tool according to the first preferred embodiment of the present invention.

FIG. 4 is a schematic drawing showing an application example of the first preferred embodiment of the present invention.

FIG. 5 is an exploded view of an output adapter for a power hand tool according to a second preferred embodiment of the present invention.

FIG. 6 is an exploded view of an output adapter for a power hand tool according to a third preferred embodiment of the present invention.

### DETAILED DESCRIPTION OF THE INVENTION

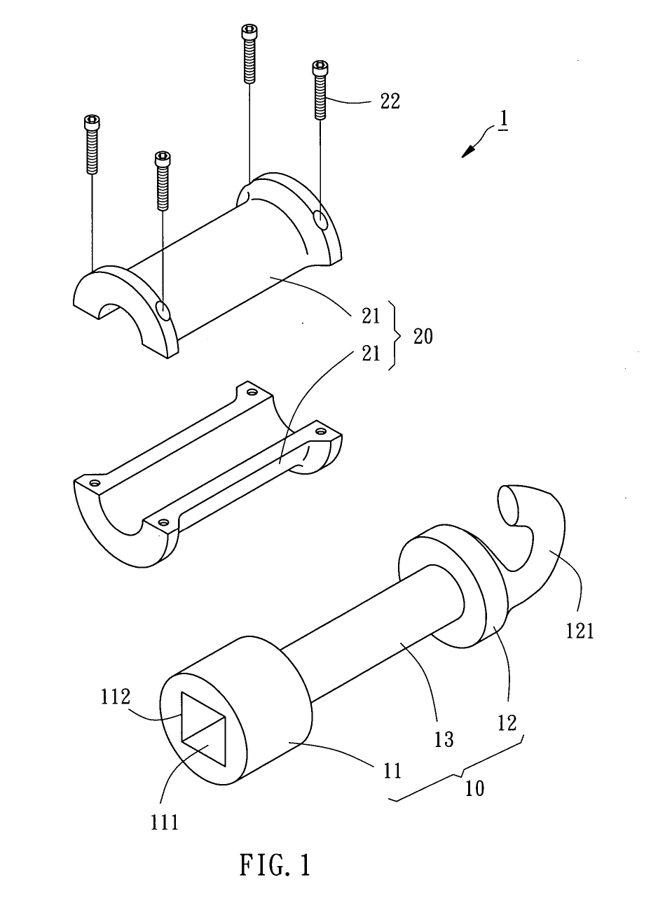

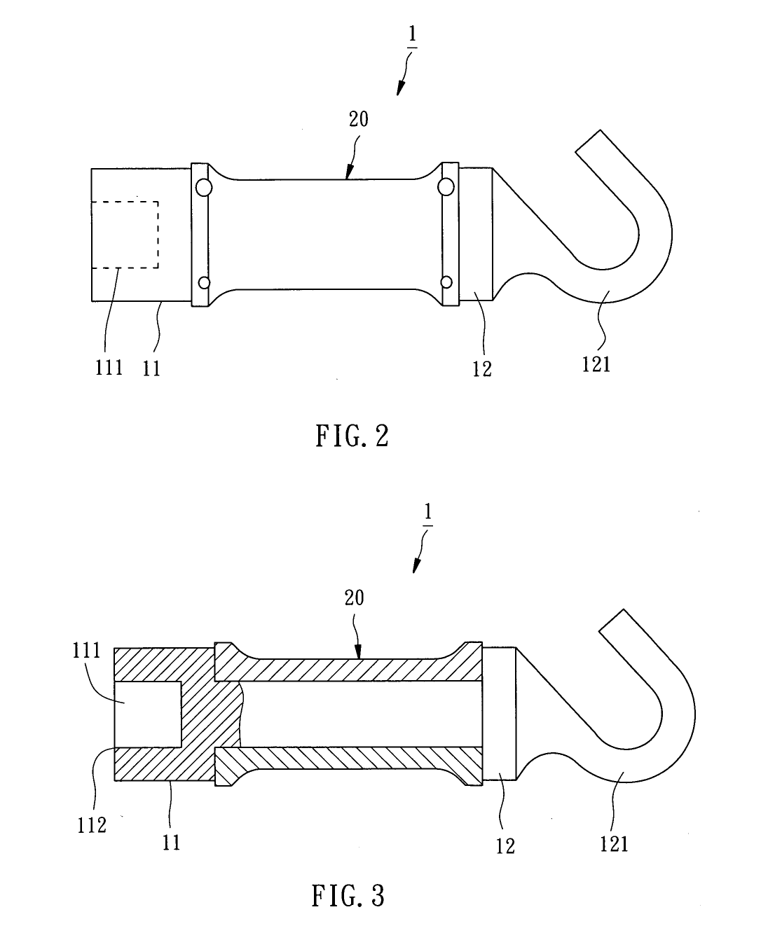

Referring to FIGS. 1-3, an output adapter 1 for a power hand tool in accordance with the first preferred embodiment of the present invention is shown comprising an adapter body 10 and a handle 20.

The adapter body 10 comprises a shank 13, a first connector 11 formed integral with one end of the shank 13, and a second connector 12 formed integral with the other end of the shank 13. The first connector 11 has a rectangular coupling hole 111, which has an opening 112 formed in the end wall of the first connector 11 for receiving the rectangular output connector of a power wrench. The second connector 12 has a hook 121.

The handle 20 is a tubular member formed of two symmetrical halves 21 abutted against each other and affixed with four screws 22. The handle 20 is mounted on the shank 13 between the first connector 11 and the second connector 12, and rotatable relative to the shank 13.

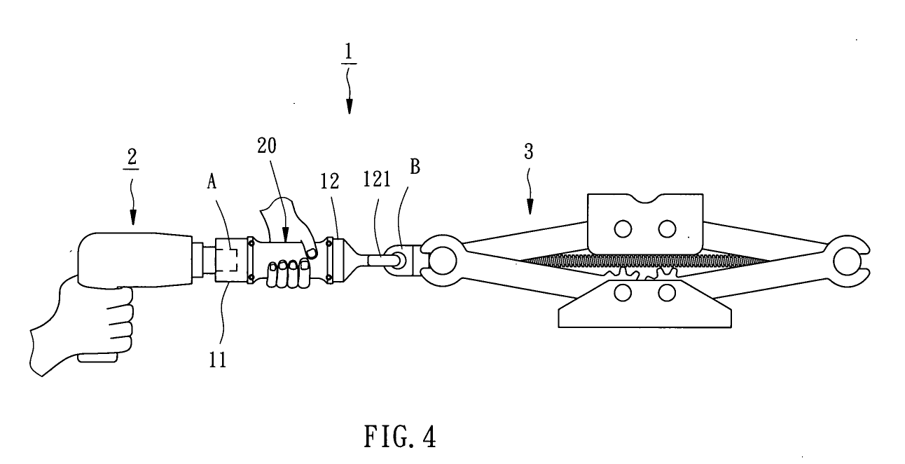

Referring to FIG. 4, the user holds the power wrench 2 with one end and the handle 20 of the output adapter 1 with the other hand, keeping the rectangular output connector (jaw) A of the power wrench 2 engaged into the rectangular coupling hole 111 of the first connector 11 of the adapter body 10 and the hook 121 of the second connector 12 of the adapter body 10 hooked in the annular power input end B of a lift jack 3. When started the power wrench 2, the lift jack 3 is moved to lift the load (motor vehicle).

As indicated above, by means of the use of the power hand tool output adapter 1, a power wrench 2 can turn a bolt or nut, and can drive a lift jack 3 to lift a motor vehicle for a repair work.

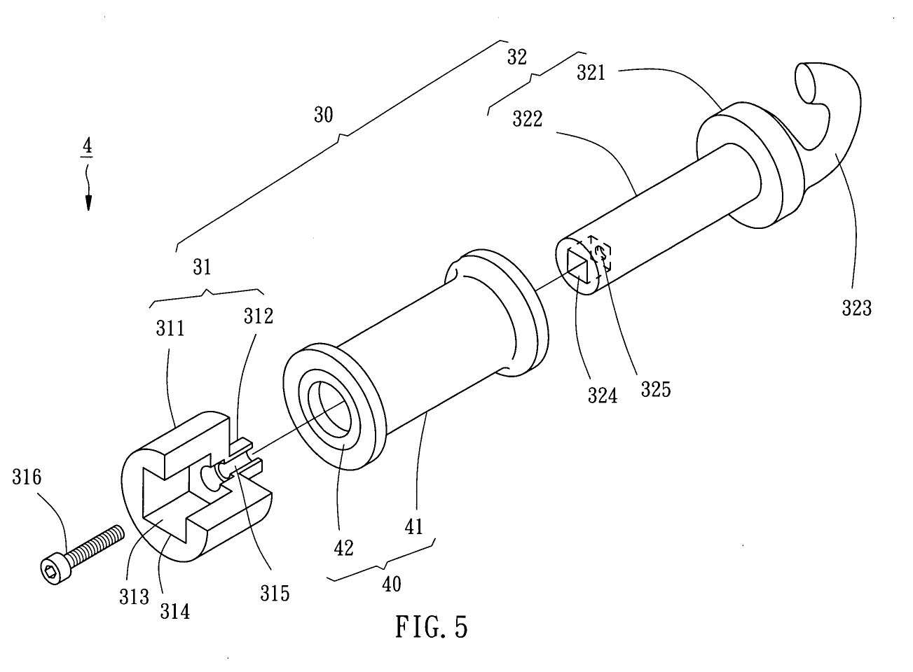

FIG. 5 is an exploded view of an output adapter 4 for a power hand tool according to the second preferred embodiment of the present invention. According to this embodiment, the power hand tool output adapter 4 comprises an adapter body 30 and a handle 40. The adapter body 30 comprises a first part 31 and a second part 32. The first part 31 comprises a connector 311 and a rectangular connecting rod 312 axially extended from one end of the connector 311. The connector 311 has a rectangular coupling hole 313, which has an opening 314 formed in the end wall of the connector 311 for receiving the rectangular output connector of a power wrench. The first part 31 has a through hole 315 extending from a bottom wall of the rectangular coupling hole 313 to a free end of the rectangular connecting rod 312. The second part 32 comprises a shank 322, and a connector 321 formed integral with one end of the shank 322. The connector 321 has a hook 323. The shank 322 has a rectangular locating hole 324, which receives the rectangular connecting rod 312 of the first part 31, and a screw hole 325 provided at the bottom wall of the rectangular locating hole 324 and axially extending toward the connector 321.

The handle 40 comprises a tubular body 41 sleeved onto the shank 322, and two bearings 42 respectively mounted in the two distal ends of the tubular body 41.

The shank 322 of the second part 32 is inserted through the tubular body 41 of the handle 40, and then the rectangular connecting rod 312 is plugged into the rectangular locating hole 324 of the shank 322, and then a screw 316 is inserted through the through hole 315 and threaded into the screw hole 325 to affix the first part 31 to the shank 322 of the second part 32, keeping the handle 40 rotatably supported on the shank 322 between the connector 311 of the first part 31 and the connector 321 of the second part 32.

Because the way to use, purpose and effect of this second embodiment are same as the aforesaid first embodiment, no further detailed description in this regard is necessary.

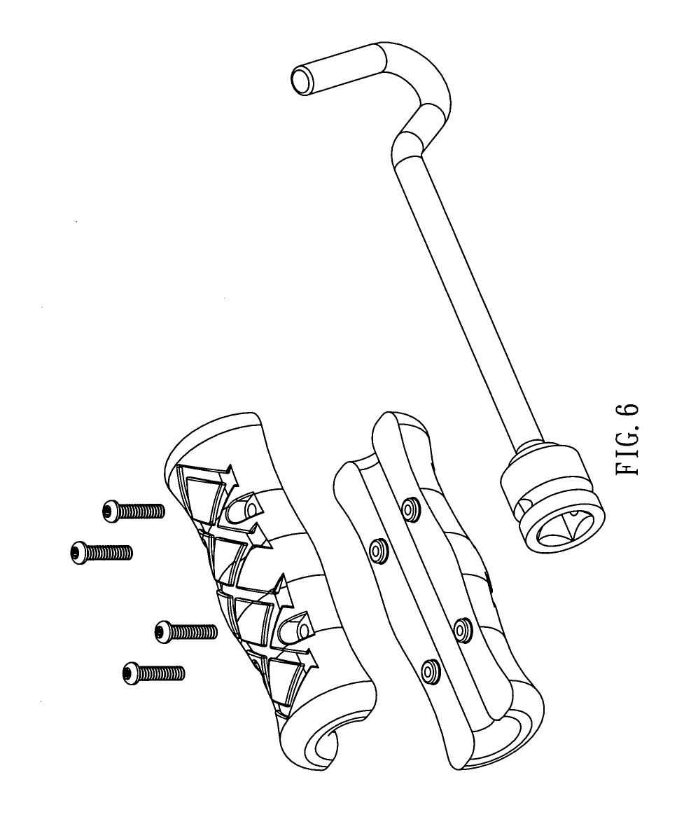

FIG. 6 shows an output adapter for a power hand tool according to the third preferred embodiment of the present invention. This embodiment is substantially similar to the aforesaid first embodiment with the exception of the outer appearance.

What is claimed is:

1. An output adapter for connecting between an output connector of a power hand tool and a rotary input connector of an apparatus for working, the output adapter comprising:
an adapter body comprising:
a first connector connectable to the output connector of the power hand tool;
a second connector connectable to the rotary input connector of the apparatus, and
a shank connected between the first connector and the second connector; and
a tubular handle rotatably sleeved onto the shank of the adaptor body.

2. The output adapter as claimed in claim 1, wherein the first connector of the adapter body has a rectangular coupling hole for receiving the output connector of the power hand tool.

3. The output adapter as claimed in claim 1, wherein the second connector of the adapter body comprises a hook and the apparatus is a lift jack having a ring input connector which is hookable by the hook of the second connector of the adapter body.

4. The output adapter as claimed in claim 1, wherein the tubular handle is comprised of two halves combined in abutment.

5. The output adapter as claimed in claim 1, wherein the adapter body is formed of a first part and a second part.

6. The output adapter as claimed in claim 5, wherein the first part comprises the first connector; the second part comprises the shank and the second connector.

7. The output adapter as claimed in claim 5, wherein the first part comprises the first connector, which has a rectangular coupling hole for receiving the output connector of the power hand tool, a rectangular connecting rod extended outwardly from the first connector, and a through hole extending from a bottom wall of the rectangular coupling hole of the first connector to a free end of the rectangular connecting rod;
wherein the second part comprises the second connector, which has a hook, the shank, which is connected with the second connector and provided with a rectangular locating hole for receiving the rectangular connecting rod of the first part, and a screw hole provided at a bottom wall of the rectangular locating hole such that a screw is inserted through the through hole of the first part and threaded into the screw hole of the second part to connect the first part and the second part together.

8. The output adapter as claimed in claim 1, wherein the tubular handle comprises a tubular body and two bearings respectively mounted in two distal ends of said tubular body.

9. A power hand tool and lift jack assembly comprising:
a power hand tool having a rotary output end;
a lift jack having a rotary input end; and
an output adapter comprising:
an adapter body comprising:
a first connector connected to the rotary output end of the power hand tool;
a second connector connected to the rotary input end of the lift jack, and
a shank connected between the first connector and the second connector; and
a tubular handle rotatably sleeved onto the shank of the adaptor body.
